(19) United States
(12) Patent Application Publication
(10) Pub. No.: US 2005/0065849 A1
(43) Pub. Date: Mar. 24, 2005

(54) Method for a variable rebate tier structure for card transactions

(76) Inventors: Erica L. Mitchell, New York, NY (US); Aliza Freud, New York, NY (US); Alan Haber, Rye Brook, NY (US); Pam A. Kornfeld, New York, NY (US)

Correspondence Address: MCDERMOTT, WILL & EMERY LLP, 227 WEST MONROE STREET, CHICAGO, IL, 60606-5096, US

(21) Appl. No.: 10/980,719

(22) Filed: Nov. 3, 2004

Related U.S. Application Data
(63) Continuation of application No. 10/306,087, filed on Nov. 27, 2002.
(60) Provisional application No. 60/416,659, filed on Oct. 7, 2002.

(51) Int. Cl. G06F 17/60

(52) U.S. Cl. 705/14; 705/35; 705/39

(57) ABSTRACT

There is provided a method for determining a rebate for a card account based on the amount of a card member's expenditures, the spending category, and on the account's revolve status during a billing period. The variable rebate method provides tiered rebate levels for card member purchases where the rebate rates vary and increase in conjunction with the level of card member purchases. A method of determining a rebate comprises determining a spending category of at least one of a plurality of transactions, determining an amount of transaction expenditures for said plurality of transactions, determining whether a card account associated with said plurality of transactions is in revolve status, selecting at least one rebate rate corresponding to said revolve status, spending category and amount of transaction expenditures, and calculating at least one rebate for at least one spending category using said at least one rebate rate. Further, a rebate may calculated for a plurality of billing periods as well as a final rebate via the aggregation of the rebates for the plurality of billing periods.

### REFERENCE TO RELATED APPLICATIONS

This application claims the benefit of the filing date of U.S. Provisional Patent Application No. 60/416,659 filed on Oct. 7, 2002.

### FIELD OF THE INVENTION

The present invention relates to the field of consumer spending incentive programs based on purchases transacted using a card and includes rebates, cash rewards, cash refunds and incentives. More particularly, there is provided a method for providing a tiered rebate structure for card member purchases or transactions based on the year-to-date accumulated spending level for a card account, the type of card transaction carried out in a billing period, and the revolve status of the card account in that same billing period.

### BACKGROUND OF THE INVENTION

Providing rebates or cash rewards to a card member as an incentive to use a particular transaction card is well known. Rebate programs are also intended to engender loyalty from card members to the card issuer, especially if the card issuer offers an attractive rebate rate for card member purchases. Numerous institutions offer and issue cards that provide this added feature and benefit to card members for purchases applicable to their card account. Cards that have associated cash rebate rewards typically include credit cards, smart cards, charge cards, debit cards, rebate cards and other transaction, purchase, and financial cards. Additionally, rebate programs are typically automated and implemented on computerized data processing systems belonging to card issuing institutions or other designated entities that provide and operate a rebate programs for the card issuing institution.

In common rebate methods used in the credit card industry, a card member is awarded a rebate, award, bonus or cash reward that is calculated based on a predetermined percentage of the total amount of purchases or expenditures carried out by the card member using a transaction card such as a credit card. The incentive provided to the card user or member can be described using various terms including bonus, reward, giveback, return, refund, award or cash back. Typically, the rebate is a fixed percentage of all the total yearly expenditures on the credit card account and does not vary depending on the amount of yearly card member expenditures. Thus, the rebate amount is calculated using the same rebate rate whether the card member spends $1000 or $10,000 in one year. Further, the rebate or reward due the card member is typically only calculated once during a fixed period, e.g. at the end of the calendar year, fiscal year or other period, such as a card membership anniversary date. The calculated rebate is then paid or credited by the institution or card issuer to the card holder.

One drawback of this type of rebate program is that there is only one rebate rate applicable to all card purchases. The applicable rebate rate, and thus the calculated rebate amount, does not depend on the type of purchase transaction conducted by the card member. For example, card purchases and transactions can be designated or classified, among others purchase categories, as “everyday spend” purchases or “non-everyday spend” purchases. An “everyday spend” purchase or transaction typically includes purchases at stand-alone supermarkets, gas stations, drugstores and home improvement stores. A “non-everyday spend” is any other type of purchase. These classifications or types of spending as well as others are well known to those of skill in the art.

Card member spending habits and patterns typically vary and are often very diverse. Some card members conduct both “everyday spend” and “non-everyday spend” purchases in generally equal proportions throughout a year or billing period. While others have either “everyday spend” or “non-everyday” purchases as a majority of their purchases or transaction. Still others may conduct purchases or transactions that could fall in to other classes or categories, for example, retail or non-retail spending, travel and entertainment or non-travel and entertainment, etc. Under a typical rebate program, the type of spending pattern is not taken in to account. Thus, card members cannot and do not realize a benefit for and there is no incentive for making one type of purchase or transaction over another since there is no distinction made in the rebate rates between the type, class or category of purchases or transaction in calculating the overall rebate amount.

Other rebate programs award rebates or rewards to card members based upon the amount of debt that a card member revolves on their card account from one billing period to the next. Typically, the card member must carry or revolve a specific debt amount on the account to be eligible for a certain rebate or for higher rebate rate. If the card member does not revolve the specified or minimum amount from one billing period to the next, no rebate is given for purchases or a lower or reduced rebate rate is applied to purchases. This approach has drawbacks that are detrimental to the card members. In order be eligible for a higher rebate, the card member must typically carry a large predetermined or specific amount of debt on their card account. This can lead to a dilemma if the card member desires to receive rebates for purchases but prefers to carrying very little or no debt. The card holder must incur more debt to received higher rebate rates. In that regard, this aspect of the program could be a disincentive for card members to use that particular card for purchases.

Other existing rebate programs can include a rebate tier structure but do not provide a cash back bonus based on the revolve status of a card member account. Additionally, existing rebate programs typically do not classify the types of transactions being conducted by card members. There is thus a need for a rebate method that provides variable or tiered rebate levels for card member purchases where applicable rebate rates increase in conjunction with the amount level of yearly purchases made by a card member and that additionally distinguishes between the type, class or category of purchases or transactions made by the card member and that provides corresponding rebate levels based on the type of transactions carried out during the year or during a billing period. There is also a need for a rebate method that rewards card members for being in a revolve status from one billing period to the next irrespective of the actual amount that is revolved.

### SUMMARY OF THE INVENTION

The present invention provides a method for determining a rebate or reward using a variable rebate tier structure for card transactions for a card member's account based on the amount of a card member's expenditures, the type, category or class of purchase or transaction, and on a card member's revolve status during a billing period.

The variable rebate method provides tiered rebate levels for card member purchases where the rebate rates vary and increase in conjunction with the level of purchase made by a card member and purchase or transaction dates. There is provided a rebate method that takes into account the type, class or category of transactions or purchases made by the card member and applies differing rebate levels based on the category and date of the purchases or transactions carried out during a billing period. The rebate method also rewards card members additional rebates and rewards when a card member's account is in revolve status from one billing period to the next independent of the actual amount that is revolved.

There is provided a method of determining a rebate comprising the steps of: a) determining a spending category of at least one of a plurality of transactions; b) determining an amount of transaction expenditures and transaction dates for the plurality of transactions; c) determining whether a card account associated with the plurality of transactions is in revolve status; d) selecting at least one rebate rate corresponding to the revolve status, spending category, and amount and date of transaction expenditures; and e) calculating at least one rebate for at least one spending category using the at least one rebate rate. In another embodiment of the method of determining a rebate further comprises the step of calculating at least one rebate for a plurality of billing periods and calculating a final rebate via the addition of the at least one rebate for the plurality of billing periods. Additionally, the calculated rebate can be either a revolve rebate or a spending category rebate.

There is also provided a method of determining a rebate comprising the steps of: a) storing a plurality of transactions occurring in a billing period including corresponding transaction dates; b) classifying each of said transactions as an “everyday spend” transaction or a “non-everyday spend” transaction; c) determining and storing an “everyday spend” transaction total, a “non-everyday spend” transaction total and a year-to-date transaction total upon completion of said billing period; d) determining a rebate tier structure corresponding to said year-to-date transaction total; e) calculating an “everyday rebate” amount using a first rebate rate corresponding to said determined rebate tier structure; f) calculating a “non-everyday rebate” amount using a second rebate rate corresponding to said determined rebate tier structure; g) determining whether a card account associated with said plurality of transactions is in revolve status; h) calculating a revolve “everyday rebate” amount using a first revolve rebate rate corresponding to said determined rebate tier structure and said “everyday spend” transaction total if said card account is in revolve status; i) calculating a revolve “non-everyday rebate” amount using a second revolve rebate rate corresponding to said determined rebate tier structure tier and said “non-everyday spend” transaction total if said card account is in revolve status; j) storing, for each of a plurality of billing periods, said “everyday rebate” amount, said “non-everyday rebate” amount, said revolve “everyday rebate” amount, and said revolve “non-everyday rebate” amount if said billing period just ended does not correspond to a final rebate calculation period; and k) calculating a final rebate amount for said card account by adding, for each of said plurality of billing periods, said “everyday rebate” amount, said “non-everyday rebate” amount, said revolve “everyday rebate” amount, and said revolve “non-everyday rebate” amount if said billing period just ended corresponds to said final rebate calculation period.

It is an object of the present invention to provide a rebate method that rewards a card member additional rebate rewards for carrying a balance on their card account, i.e., if the card account is in revolve status.

It is an object of the present invention to provide a rebate method that rewards a card member for their purchase behavior.

It is an object of the present invention to provide a rebate method that rewards a card member for revolve behavior.

It is an object of the present invention to provide card members a rebate method that allows them to earn rebate rewards faster by spending in “everyday spend” locations.

It is an object of the present invention to provide a rebate method that gives card members an increased rebate reward for using their card in “everyday spend” transactions when the card account is in revolve status.

It is an object of the present invention to provide a rebate method that gives card members an increased rebate reward for using their card in “non-everyday spend” transactions when the card account is in revolve status.

It is an object of the present invention to provide a rebate method that provides card members with increased rebate rates or levels that correspond to increased levels or tiers for card member purchases and transactions.

It is an object of the present invention to provide a rebate method that provides card members with selective rebate rates or levels corresponding to levels or tiers for card member purchases and transactions.

It is an object of the present invention to provide a rebate method that provides card members with selective rebate rates or levels corresponding to the type, class or category of card member purchases and/or transactions.

It is an object of the present invention to provide a rebate method that provides card members with selective rebate rates or levels corresponding to the revolve status of a card member.

It is an object of the present invention to provide a rebate method that rewards a card member additional rebate rewards for carrying a balance on a card account, i.e., if the card account is in revolve status, where the card account is associated with a transaction card, a financial card, a credit card, a charge card, a debit card, a smart card, digital card, a bank card, a commerce card, or an electronic transaction card.

It is an object of the present invention to provide a method for determining a rebate for a plurality of billing periods where a billing period can be a week, a month, a fiscal year, or a calendar year.

It is an object of the present invention to provide a method for determining a final rebate via the addition of a plurality of calculated rebates corresponding to a plurality of billing periods where the final rebate can be calculated annually, semi-annually, at the end of a fiscal year, at the end of a calendar year, or on the anniversary date of a card account.

It is an object of the present invention to provide a method for determining a rebate using a rebate tier structure that is comprises of a plurality of card account spending tiers and corresponding rebate rates for the spending tiers.

It is an object of the present invention to provide a rebate method that gives card members selective or increased rebate rewards for using their card on retail, non-retail, wholesale, non-wholesale, travel, non-travel, entertainment, non-entertainment transactions when the card account is in revolve status.

The following drawings and description set forth additional advantages and benefits of the invention. More advantages and benefits will be obvious from the description and may be learned by practice of the invention.

### BRIEF DESCRIPTION OF THE DRAWINGS

The present invention may be better understood when read in connection with the accompanying drawings, of which:

FIGS. 1A and 1B depict a flow diagram for a method for determining a rebate for a customer according to an embodiment of the present invention; and

FIG. 2 depicts a table illustrating an embodiment of a rebate tier structure having three spending levels and a rebate bonus rate parameter with corresponding rebate rates that could be used in the method shown in FIGS. 1A and 1B.

### DETAILED DESCRIPTION

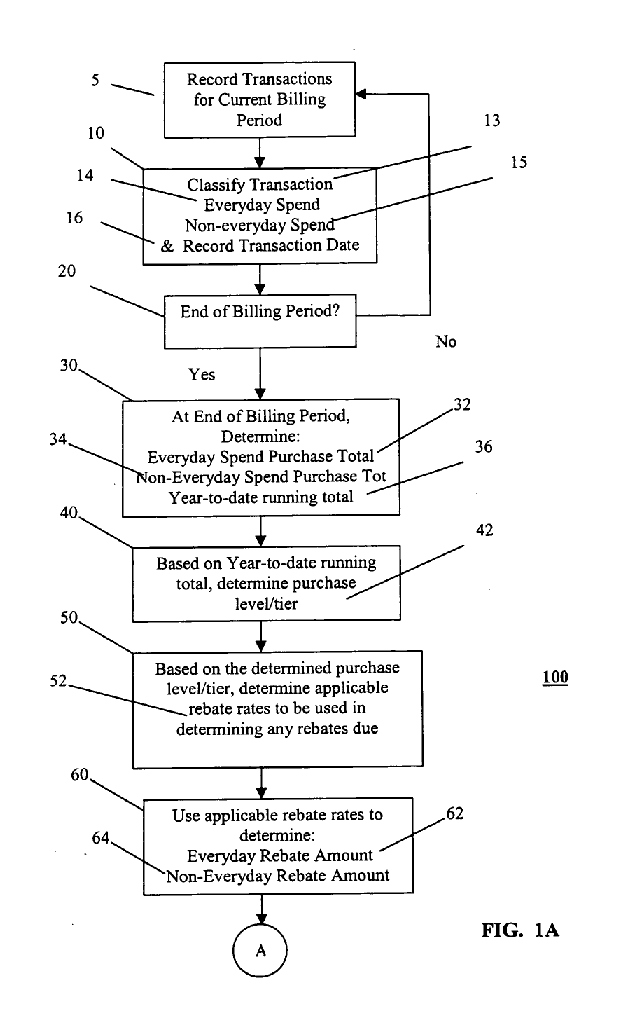

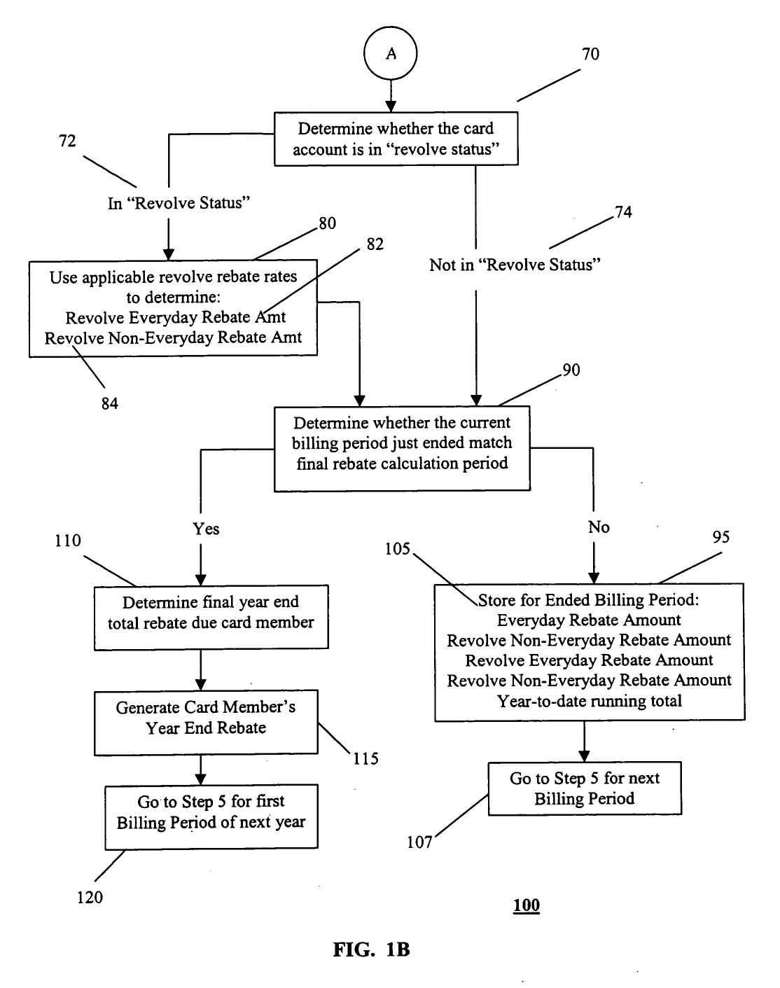

FIGS. 1A and 1B illustrate an embodiment of a variable rebate method 100 for determining a rebate as an incentive or reward to card members to use their cards for their purchases and transactions. The rebate calculation or determination for a card account can be carried out at any point in time, but is typically done at the end of a billing period, at the end of each of a plurality of billing periods, at the end of the year or any other periodic interval chosen by a card issuer. In one embodiment, a rebate calculation is carried out on the anniversary date of a card member's account. The calculated rebate amount, and the rebate rates used to calculate the account rebate can vary depending on the amount of purchase transactions carried out by a card member during the year or a predetermined billing period, the type, class or category of the transaction or purchase, e.g., an “everyday spend” or “non-everyday spend” transaction, and whether there is a revolving balance on the card member's account, i.e., whether or not a customer carries an account balance from a current billing period to a subsequent billing period.

The embodiment shown in FIGS. 1A and 1B can be carried out or implemented on a computerized system running and executing appropriate application programs related to rebate reward programs and applications as are well known to those of skill in the art. For example, a rebate reward program could be implemented by a system (not shown) comprising a card member card or transaction card, a card reader, memory storage, and a transaction computer or processor with access to a card member information database and an associated card member account. Those of skill in the art will readily recognize that such a system and other similar computerized and non-computerized systems could be used to implement the rebate method embodiment shown in FIGS. 1A and 1B. Further, the embodiment illustrated in FIGS. 1A and 1b for determining a rebate can be used with rebate programs associated with a variety of transaction cards. Those of skill in the art will readily recognize that this can include among others, financial cards, credit cards, a charge cards, debit cards, smart cards, digital cards, bank or banking cards, commerce cards, or other electronic transaction cards.

Referring again to FIGS. 1A and 1B, there is shown the steps to carry out a preferred embodiment of the variable rebate method 100 in accordance with the present invention. In step 5, all transactions during a billing period, e.g. during a current month, are recorded and stored. In step 10, each user purchase or transaction is classified or identified with a spending category 13 as either an “everyday spend” 14 or “non-everyday spend” 15 transaction. Further, in step 10, the transaction date 16 is also recorded for each transaction.

In step 10 of the preferred embodiment, the transactions are categorized as either an “everyday spend” 14 or “non-everyday spend” 15 transaction. However, the category can be any category defined, selected or chosen by a card issuer or operator of the rebate program or method. Further, the transactions are broken down into two categories. Those of skill in the art will readily recognize that the number of categories could be selected to be more or less than simply two categories. Further, the actual categories could be selected or defined to be something in addition to and/or other than an “everyday spend” 14 or “non-everyday spend” 15 transaction. For example, the categories could be selected or defined to be transactions such as non-retail, wholesale, non-wholesale, travel, non-travel, entertainment, non-entertainment, internet or web, non-internet or non-web, online, offline, etc., among others as defined by the card issuer or program administrator. Further, the number of categories could be any number or combination of transaction categories. Thus, although the preferred embodiment is discussed with respect to a first and second type or category of transactions, an “everyday spend” 14 or “non-everyday spend” 15, respectively, those of skill in the art that more or less categories could be defined or used in the preferred method.

In step 20, a determination is made as to whether the end of the billing period has been reached, for example, the end or beginning of a month or some other selected date. Those of skill in the art will recognize that a card issuing institution could set the end of the billing period as desired. If the billing period has not ended, then the transaction type 13 and date 16 for card member purchases continue to be recorded in the current billing period as noted in steps 5 and 10.

In step 30, upon the completion of the current billing period, the “everyday spend” purchase total 32, the “non-everyday spend” purchase total 34, and the year-to-date running total 36 of all purchases or transaction expenditure made by a card member are calculated and stored. The “everyday spend” purchase total 32 is determined by adding each “everyday spend” transaction 14 for the current billing period just ended using the recorded transaction date 16. The “non-everyday spend” purchase total 34 is determined by adding each “non-everyday spend” transaction 15 for the current billing period just ended using the recorded transaction date 16. The year-to-date running total 36 is determined by adding all purchases and transactions made by a card member during the year up to and including transactions in the current billing period that just closed.

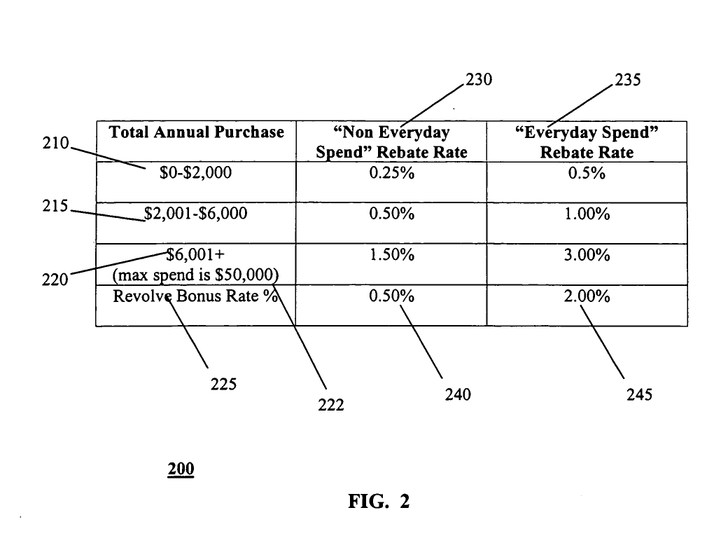

In step 40, the appropriate purchase level or tier 42 for the card member account is determined. Preferably, there is a rebate tier structure (shown in FIG. 2) with a plurality of predetermined tiers or levels with corresponding rebate reward levels in which a card member account may fall into. The card member account level or tier 42 is determined by comparing the year-to-date running total 36, found in step 30, and comparing it against the predetermined or pre-defined tiers or levels 210, 215 and 220 of the rebate tier structure (shown in FIG. 2).

FIG. 2 shows that in this embodiment, there are three overall or total annual purchase spending levels or tiers 210, 215 and 220 with corresponding “everyday spend” or “non-everyday spend” rebate rates or tiers 230 and 235 in the rebate tier structure. Those of skill in the art will recognize that the total annual purchase parameters 210, 215, and 220, and the associated “everyday spend” or “non-everyday spend” rebate rate parameters 230 and 235 can be selected by an institution as desired to fit their particular rebate programs. In the embodiment shown in FIG. 2, there are shown three levels or tiers 210, 215 and 220, though more or less levels could have been used.

The first level 210 preferably comprises total annual purchases in a range of $0 through $2,000. The corresponding “everyday spend” rebate rate parameter 235 is preferably 0.5%. The corresponding “non-everyday spend” rebate rate parameter 230 is preferably 0.25%. The second level 215 preferably comprises total annual purchases in the preferred range of $2,001 through $6,000. The corresponding “everyday spend” rebate rate parameter 235 is preferably 1.0%. The corresponding “non-everyday spend” rebate rate parameter 230 is preferably 0.5%. The third level 220 preferably comprises total annual purchases in the preferred range of $6,001 and greater. The corresponding “everyday spend” rebate rate parameter 235 is preferably 3.0%. The corresponding “non-everyday spend” rebate rate parameter 230 is preferably 1.5%. Again, these ranges are only preferred ranges and may change to suit the needs of the institution awarding the rebates. There is also shown, that in this embodiment, the maximum total annual purchases or spend 222 for which rebates will be calculated is $50,000. Again, this parameter 222 may be changed as desired by an institution.

The rebate tier structure shown in FIG. 2 further illustrated a supplemental revolve rebate bonus rate parameter 225 that, in the embodiment shown in FIGS. 1A and 1B, could be used in determining a supplemental revolve rebate bonus when a card member's account is in “revolve status”. There are preferably two revolve rebate bonus rates, a first and second revolve rebate rate 245 and 240, that respectively can be used to calculate revolve rebates for the “everyday spend” purchase totals 32 and “non-everyday spend” purchase total 34 for the current month just ended. Again, though certain revolve or bonus rates are listed, i.e., 0.5% and 2.0%, other revolve rebate rates could be used as desired by an institution. Moreover, unlike the “everyday spend” rebate rates 235 and the “non-everyday spend” rebate rates 230 which correspond to a total annual purchase tier or level 210, 215 and 220, the supplemental revolve or bonus rebate rates come into play preferably when the card member's account is in revolve status, or some other parameter is met, as discussed below with respect to step 70. That is, the revolve rebate rates 240 and 245 preferably correspond or are applicable when a card members' account is in revolve status for a current month that just ended.

In step 50, once the appropriate purchase level or tier 42 of the rebate tier structure 200 has been determined upon the completion of the current billing period, the corresponding and applicable rebate rates 230 and 235 can be used to determined any rebates that may due to a card member account. The rebates due for the “everyday spend” 14 and “non-everyday spend” 15 transactions or purchases made in the just completed billing period are determined using the transaction dates and the rebate rates 230 and 235 that correspond to the appropriate purchase level 42, 210, 215 and 220.

In step 60, for the stored “everyday spend” purchase total 32 for the current month just ended, the “everyday rebate” amount 62 is calculated by using the corresponding stored transaction dates and applicable “everyday spend” rebate rate or factor 235 that corresponds to the appropriate purchase level 42, determined in step 40. Additionally, for the stored “non-everyday spend” purchase total 34 for the current month just ended, the “non-everyday rebate” amount 64 is calculated by using the corresponding stored transaction dates and applicable “everyday spend” rebate rate or factor 230 that corresponds to the appropriate purchase level 42. Step “A” in FIGS. 1A and 1B preferably shows the continuation of the process from FIG. 1A to FIG. 1B without interruption.

In step 70, shown in FIG. 1B, upon receipt of payment from a card member after the current billing period has ended, a determination is made as to whether the card member account is in “revolve status”. If the card member paid off his entire account balance for the current billing period just ended, then the card member's account is not in revolve status. If the account is not in revolve status for the current month just ended, no revolve or bonus rebates will be awarded to this card member account for the current month just ended. In this scenario, the process would skip step 80 and proceed to step 90.

The process continues to Step 80 when the card account is in revolve status after the just ended current billing period. In step 80, for the stored “everyday spend” purchase total 32 for the current month just ended, a supplemental or revolve “everyday rebate” amount 82 is calculated by using a “everyday spend” revolve or bonus rebate bonus rate 245 (shown in FIG. 2). Additionally, for the stored “non-everyday spend” purchase total 34 for the current month just ended, a supplemental or revolve “non-everyday rebate” amount 84 is calculated by using the a “non-everyday spend” revolver or bonus rebate rate 240 (shown in FIG. 2).

In step 90, a determination is made as to whether the current billing period just ended corresponds to a final rebate calculation period, such as the end the year or card account anniversary date. The final rebate calculation period could be an annual or a semi-annual time period, the end of a fiscal year, the end of a calendar year, the anniversary date for a card account or any other designated period selected by the card issuer or rebate program administrator.

In step 95, if the current billing just ended is not the final rebate calculation period such as the end of the year, the “everyday rebate” amount 62, the “non-everyday rebate” amount 64, the supplemental “everyday rebate” amount 82, the supplemental “non-everyday rebate” amount 84, and update the year-to-date running total 36 of all transaction or purchase expenditures made by a card member during the year, including all purchases made in the current billing period just ended, are stored. The process 100 then preferably proceeds to Step 107 which indicates that the process should now proceed to Step 5 and repeat Steps 5 through 90 for the next or subsequent billing period. These steps can repeat for a plurality of billing periods until a current billing period corresponds to the final rebate calculation period. Those of skill in the art will recognize that a billing period could be a week, a month, six months, a yearn annual, fiscal year, a calendar year or any other designated period selected by the card issuer or rebate program administrator.

In step 110, if the current billing period just ended is the final rebate calculation period, e.g., the end of the year, the final year end total rebate or final rebate amount due to the card member is determined. The final year end total rebate is calculated by adding the “everyday rebate” amount 62, “non-everyday rebate” amount 64, supplemental “everyday rebate” amount 82, and supplemental “non-everyday rebate” amount 84 previously calculated and stored for each billing period recorded prior to the final rebate calculation period.

In step 115, the calculated final year end total rebate can be generated and applied or sent to the card member for the year just completed. The process 100 can now proceed to step 120 which indicates that the process can proceed to step 5 to begin calculation and storage for a next rebate calculation period such as the next or subsequent year.

The invention has been described and illustrated with respect to certain preferred embodiments by way of example only. Those skilled in that art will readily recognize that the preferred embodiments may be altered or amended without departing from the true spirit and scope of the invention. Therefore, the invention is not limited to the specific details, representative devices, and illustrated examples in this description. The present invention is limited only by the following claims and equivalents.

1-35. (cancelled).

36. A method for redeeming a rebate for an account comprising the steps of:
determining a transaction category from a plurality of transaction categories for each of a plurality of transactions;
determining a total transaction expenditure amount for each of said plurality of transaction categories and a total transaction expenditure amount for all transactions related to the account;
selecting a rebate rate from a plurality of tiered rebate rates for each of said plurality of transaction categories based on one or more of said total transaction expenditure amounts; and
calculating a rebate using said selected rebate rate for each of said plurality of transaction categories and one or more of total transaction expenditure amounts; and
providing the rebate at a final rebate calculation period.

37. The method of claim 36 wherein said final rebate calculation period corresponds to the anniversary of the inception of the account.

38. The method of claim 36 wherein said final rebate calculation period corresponds to the accumulation of a predetermined rebate amount total.

39. The method of claim 36 wherein said final rebate calculation period corresponds to the accumulation of a rebate amount total equal to or greater than $25.

40. The method of claim 36 wherein said plurality of transaction categories includes an internet purchases category.

41. A method for determining a rebate for an account comprising the steps of:
determining a transaction category from a plurality of transaction categories for each of a plurality of transactions;
determining a total transaction expenditure amount for each of said plurality of transaction categories;
determining whether the account is in revolve status;
selecting a rebate rate from a plurality of rebate rates for each of said transaction categories based upon whether the account is in revolve status; and
calculating a rebate using said selected rebate rates; and
providing the rebate at a final rebate calculation period.

42. The method of claim 41 wherein said final rebate calculation period corresponds to the anniversary of the inception of the account.

43. The method of claim 41 wherein said final rebate calculation period corresponds to the accumulation of a predetermined rebate amount total.

44. The method of claim 41 wherein said final rebate calculation period corresponds to the accumulation of a rebate amount total equal to or greater than $25.

45. The method of claim 41 wherein said account is in revolve status when the monthly revolve balance is $500 or more.

46. A method for determining a rebate for an account comprising the steps of:
determining a transaction category from a plurality of transaction categories for each of a plurality of transactions;
determining a total transaction expenditure amount for each of said plurality of transaction categories and a total transaction expenditure amount for all transactions related to the account;
determining whether the account is in revolve status;
selecting a rebate rate from a plurality of tiered rebate rates for each of said transaction categories based on one ore more of said total transaction expenditure amounts and whether the account is in revolve status;
calculating a rebate using said selected rebate rates; and
providing the rebate at a final rebate calculation period.

47. The method of claim 46 wherein said final rebate calculation period corresponds to the anniversary of the inception of the account.

48. The method of claim 46 wherein said final rebate calculation period corresponds to the accumulation of a predetermined rebate amount total.

49. The method of claim 46 wherein said final rebate calculation period corresponds to the accumulation of a rebate amount total equal to or greater than $25.

50. The method of claim 46 wherein said account is in revolve status when the monthly revolve balance is $500 or more.
